(19) United States
(12) Patent Application Publication
(10) Pub. No.: US 2015/0085040 A1
(43) Pub. Date: Mar. 26, 2015

(54) LED INK CURING APPARATUS

(71) Applicants: Malcolm RAE, West Sussex (GB); Benjamin TYLER, West Sussex (GB); Robert RAE, West Sussex (GB)

(72) Inventors: Malcolm RAE, West Sussex (GB); Benjamin TYLER, West Sussex (GB); Robert RAE, West Sussex (GB)

(73) Assignee: GEW (EC) LIMIITED, West Sussex (GB)

(21) Appl. No.: 14/494,058

(22) Filed: Sep. 23, 2014

(30) Foreign Application Priority Data
Sep. 23, 2013 (GB) 1316830.7

(51) Int. Cl. B41J 11/00

(52) U.S. Cl. CPC B41J 11/002
USPC 347/102

(57) ABSTRACT

An LED array for UV print curing comprising a plurality of LED modules grouped into a plurality of LED zones, each LED zone, comprising one or more LED modules and each LED module comprises a plurality of LEDs, wherein, in use, each LED zone is controllable independently of the other zones by a controller according to a pre-determined curing map.

### CROSS REFERENCE TO RELATED APPLICATIONS

This application claims priority to and the benefit of GB Patent Application Serial No. 1316830.7, filed on Sep. 23, 2013, the content of which is incorporated herein by reference in its entirety.

### BACKGROUND

The present invention relates to an LED array for use in a UV ink curing apparatus.

The use of ultra violet (UV) LED (light-emitting diode) arrays for ink curing is becoming increasingly popular as an alternative to traditional mercury arc UV lamps. However, the manufacture and use of UV LED arrays in ink curing systems suffers from many problems.

For example, the LEDs provided within an LED array are often difficult to replace in the event of failure. In addition, it can be complicated to provide large LED arrays in which individual LEDs or groups of LEDs within the array can be switched on or off as required. For example, it is often desirable to provide an LED array which is suitable for use with a variety of substrate widths. Accordingly, it would be desirable to provide a large LED array in which some LEDs can be switched off to allow the remaining LEDs to be left on and correspond to the width of substrate in question.

Whilst LED arrays are known in which individual LEDs or groups of LEDs can be switched on and off, the LEDs in such arrays are individually controllable. This makes the manufacture of such arrays difficult and their use problematic.

European patent publication EP2508255 discloses a UV irradiation apparatus comprising a memory unit, in which there is stored a correction table for each candidate value of an output set value of each of the LED units. A feedback control, relying on detection of the individual UV doses that are emitted by each LED unit, is used to set the magnitude of the supply power to each of the LED units. EP2508255 discloses an apparatus for enhancing UV dose uniformity by keeping output constant regardless of the emission time.

International patent publication WO2011/097694 discloses modular high density LED array light sources wherein the density of LEDs is higher at the ends or edges of the modules of LEDs to improve uniformity of irradiance over the illuminated area between modules and reduce the discontinuity in irradiance due to edge or wall effects caused by the spacing of the LEDs.

Prior art LED arrays are concerned with achieving uniformity of power across the LED arrays using active monitoring and control. Prior art LED arrays are not suited to applications requiring non-uniformity of output.

The present invention sets out to provide an improved LED array, which alleviates the problems described above.

In one aspect, the invention provides an LED array for UV print curing comprising a plurality of LED modules grouped into a plurality of LED zones, each LED zone comprising one or more LED modules and each LED module comprises a plurality of LEDs, wherein, in use, each LED zone is controllable independently of the other zones by a control element according to a pre-determined curing map.

It is understood that in the context of the present invention the pre-determined “curing map” translates the UV print effect that is to be achieved into a representation for controlling the output of each LED zone. The curing map is a representation of pre-determined output parameters across the LED zones. For example, the curing map is a representation of the variation in output parameters across the LED zones; although, it is also understood that the present invention can also achieve a uniform output across the LED zones if required.

The present invention provides a significant advantage over known LED arrays because it allows for a large LED array to be produced and for zones of LEDs within the array to be controlled independently of other zones of LEDs without all of the LEDs being controlled individually. The present invention enhances curing performance and greatly increases the applications to which LED UV print curing devices and methods can be applied.

In addition, the same control element can be used to control a set number of zones irrespective of how many LED modules are provided in each zone. This greatly simplifies manufacture and allows the size of the lamp and the LED zones within the lamp to be customized to suit curing needs. For example, the LED array formed by zones can be provided at any desired width and the zones within the array can be provided at a width to suit specific widths of substrate within the overall width of the array.

Furthermore, the present invention allows for the use of LED UV print curing to produce a variable print effect across the substrate in accordance with a pre-determined pattern. The present invention allows for the careful control of non-uniformity of UV output across the LED array.

Preferably, the pre-determined curing map is a representation for controlling the output of each LED zone in respect of any of the following parameters: UV power output; UV output intensity; UV output frequency; UV output duration.

Preferably, the pre-determined curing map is a representation for controlling the UV power output of each LED zone in a range of about 0.01% and 100% of maximum UV power output.

It has been found that ensuring all LED zones are switched on allows the present invention to offer improved performance and be applicable to the desired wide range of print curing applications.

Preferably, the zones are connectable to a single power supply.

Preferably, each LED module comprises at least about 56 LEDs, preferably between about 56 and about 98 LEDs, more preferably about 70 LEDs, still more preferably about 75.

Optionally, each LED module comprises 2 to 400 LEDs.

Preferably, the LED modules are individually replaceable.

Preferably, the LED modules are provided adjacent to each other (side-by-side)

Preferably, the LED zones are provided adjacent to each other (side-by-side).

Preferably, a control element for controlling each LED zone independently of the other zones is provided external to the array. Alternatively, a control element for controlling each LED zone independently of the other zones is provided within the array.

Preferably, the LEDs are UV LEDs.

Preferably, the LED array is a UV LED array.

According to another aspect of the present invention, there is provided a UV ink curing apparatus comprising one or more LED arrays of the present invention.

Preferably, the ink curing apparatus comprises at least one power supply.

Preferably, the power supply comprises an output for each LED zone of an array.

Preferably, the apparatus comprises a power supply for each array in the apparatus.

Preferably, the ink curing apparatus comprises a control element for controlling each LED zone independently of the other zones. More preferably, the control element allows each LED zone to be switched on and off independently of the other zones. Optionally, the control element allows the UV output power of each LED zone to be varied over a range of between about 0.01% and about 100% of the maximum UV output power.

Still more preferably, the control element controls the output of each LED zone independently of all of the other LED zones.

A diverse range of UV print curing effects can be achieved using the control element of the present invention; in addition to switching individual LED zones on and off the power level of each zone can be varied, whilst keeping all zones and all modules switched on. For example, the power output can be varied by the control element (e.g., an LED controller) controlling the UV intensity, duration and frequency (e.g., color or wavelength). This allows for the size and shape of the print curing area to be varied and also for the print effect to be varied. The present invention is suited to a wide variety of printing applications. In a third aspect the present invention provides a UV print curing method comprising the steps of grouping a plurality of LED modules into a plurality of LED zones; plotting a pre-determined curing map; and controlling the output of LED modules within the plurality of LED zones according to the pre-determined curing map. Preferably, the UV print curing method of the present invention plots the pre-determined curing map with respect to any of the following parameters: UV power output; UV output intensity; UV output frequency; UV output duration

For the purposes of clarity and a concise description, features are described herein as part of the same or separate embodiments; however it will be appreciated that the scope of the invention may include embodiments having combinations of all or some of the features described.

### BRIEF DESCRIPTION OF THE DRAWINGS

The invention will now be described by way of example with reference to the accompanying drawings, in which:

FIG. 1 is a cross-sectional view through an array constructed according to the present invention;

FIG. 2 shows a plan view of a substrate-facing side of an array according to the present invention;

FIG. 3 shows a schematic view of how an array of the present invention is connected to a control element and power supply; and

FIG. 4 shows two examples of how the present invention is applied to print curing of a substrate.

The present invention relates to an LED array for use in a UV curing system.

Within this specification, the term “LED module” means a unit containing one or more LEDs that is supplied as a light source.

Within this specification, the term “about” means plus or minus 20%, more preferably plus or minus 10%, even more preferably plus or minus 5%, most preferably plus or minus 2%.

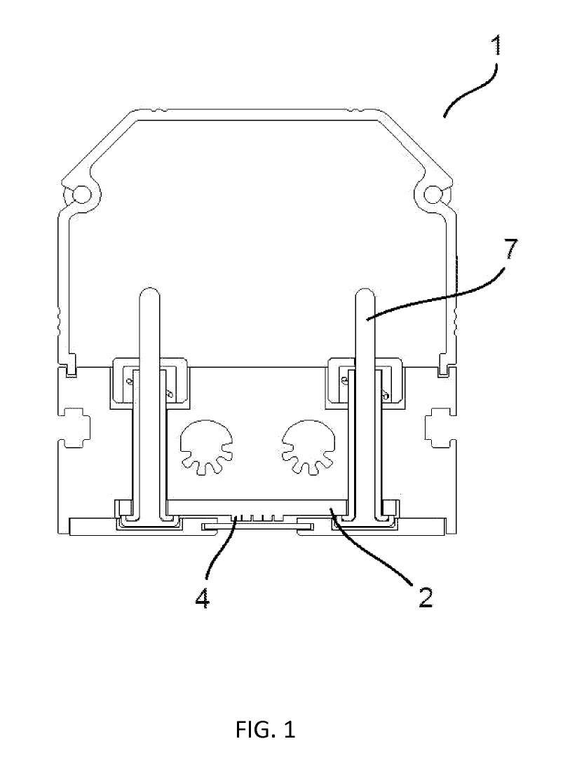

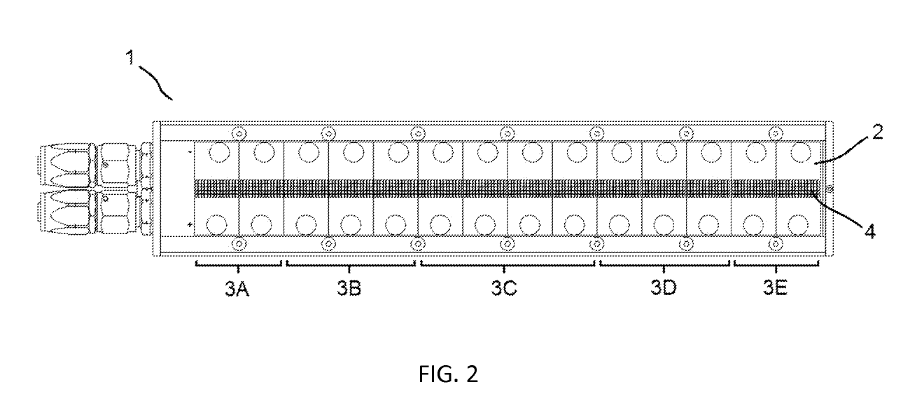

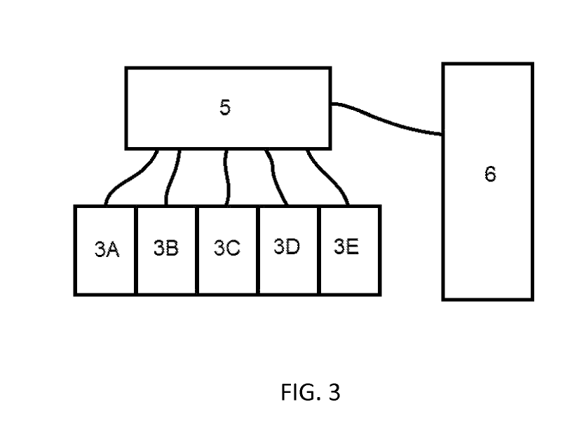

Referring to FIGS. 1 and 2 there is shown an LED array 1 for UV print curing comprising fourteen LED modules 2 grouped into five LED zones 3A, 3B, 3C, 3D, 3E. Zones 3A and 3E include two LED modules 2, zones 3B and 3D include three LED modules 2, and zone 3C includes four LED modules 2. Each LED module 2 comprises a plurality of LEDs 4. Each LED zone 3 is controllable independently of the other zones by a control element or controller 5, as shown schematically in FIG. 3.

The controller 5 controls each LED zone 3 irrespective of how many LED modules 2 are provided in each LED zone 3. For example, to provide the widest curing area all five LED zones are switched on. For narrower curing areas one or more of the zones can be switched off. For example, one or both of the outer zones 3A and 3E could be switched off to narrow the curing area. Alternatively, zones 3A, 3B, 3D and 3E could be switched off to leave only the central zone 3C in operation. It will be appreciated that more or less zones 3 could be provided each containing more or less LED modules 2. The number of LED modules provided in each zone increases with array length. The maximum number of LED modules per zone is limited only by the power supply capacity. In the same way, the maximum number of zones is limited only by the power supply capacity.

As shown schematically in FIG. 3, the zones are connected to a single power supply 6 via the controller 5. The power supply 6 includes an independent output for each zone.

The LED modules 2 are mounted within the array 1 using pins 7 such that they are individually replaceable.

The LED modules 2 are provided adjacent to each other which, in turn, means that the LED zones 3 are also provided adjacent to each other.

In the example shown, the controller 5 is provided external to the lamp 1. However, it will be appreciated that the controller 5 could be provided within the lamp 1.

The control element controls the LED modules 4 according to a pre-determined “curing map”. The curing map translates the UV print effect that is to be achieved into a representation for controlling the output of each LED module 4 within each of the LED zones 3A, 3B, 3C, 3D, 3E. The curing map is a representation of the variation across the LED zones 3A, 3B, 3C, 3D, 3E; although, it is also understood that the present invention can also achieve a uniform output across the LED zones 3A, 3B, 3C, 3D, 3E if required.

In addition to switching individual LED zones 3A, 3B, 3C, 3D, 3E on and off, the power level of each LED zone 3A, 3B, 3C, 3D, 3E can be varied. For example, the power output can be varied by the control element or controller to control the UV intensity, duration and frequency (e.g., color or wavelength). This allows for the size and shape of the print curing area to be varied and also for the print effect to be varied. The present invention is suited to a wide variety of printing applications.

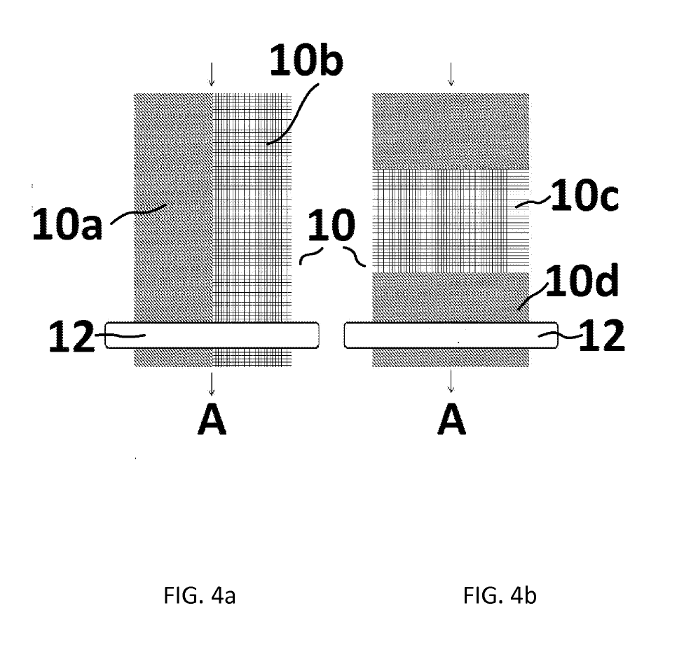

Referring to FIG. 4, an example embodiment of how the present invention is applied to UV print curing is shown. The arrow A in FIGS. 4a and 4b indicates the direction that the substrate web 10 travels through the LED array 12 of the UV print curing apparatus.

Referring to FIG. 4a, the substrate 10 comprises two distinct regions 10a and 10b, to each of which a different ink is applied. The regions 10a and 10b run parallel to each other along the direction of travel of the substrate 10. Each ink requires a different total UV irradiance to achieve acceptable curing. For example, the ink applied to region 10a requires 3 W/cm² irradiance to cure and the ink applied to region 10b requires 5 W/cm² to cure. If excess UV power, i.e. a greater irradiance, were output to be incident on the substrate web this would be detrimental by resulting in over-curing of the ink applied to the substrate. This would also increase the cost and environmental impact of the curing process.

Using the device and method of the present invention a pre-determined curing map is plotted to take into account the different required irradiance in region 10a and region 10b. The LED array 12, past which the substrate web 10 is moved, is grouped into a plurality of LED zones, which allows the intensity of the LEDs in LED zones that will cure region 10a to emit UV radiation at an irradiance of 3 W/cm² and the LEDs in LED zones that will cure region 10b to emit UV radiation at an irradiance of 5 W/cm².

Referring to FIG. 4b, the substrate 10 comprises two distinct regions 10c and 10d, to each of which a different ink is applied. The regions 10c and 10d are parallel to each other and perpendicular to the direction of travel A of the substrate 10 through the LED array 12 of the UV print curing apparatus. Each ink requires a different total UV irradiance to achieve acceptable curing. For example, the ink applied to region 10c requires 5 W/cm² irradiance to cure and the ink applied to region 10d requires 3 W/cm² to cure.

Using the device and method of the present invention a pre-determined curing map is plotted to take into account the different required irradiance in region 10c and region 10d. The LED array 12, past which the substrate web 10 is moved, is grouped into a plurality of LED zones, which allows the intensity of LEDs in the LED zones that will cure region 10d to emit UV at an irradiance of 3 W/cm² for the correct period of time to allow curing of region 10d i.e. when region 10d passes under the pre-determined LED zones of the apparatus. The LEDs in the LED zones that will cure region 10c then emit UV at an irradiance of 5 W/cm² for the correct period of time to allow curing of region 10c, i.e. when region 10c passes under the pre-determined zones of the apparatus.

The above described embodiments have been given by way of example only, and the skilled reader will naturally appreciate that many variations could be made thereto without departing from the scope of the claims. For example, the variety of curing patterns and effects shown in Figure is only a simple illustration of the complex applications to which the present invention can be applied.

1. An LED array for UV print curing comprising a plurality of LED modules grouped into a plurality of LED zones, each LED zone comprising one or more LED modules and each LED module comprises a plurality of LEDs, wherein each LED zone is controllable independently of the other zones by a control element according to a pre-determined curing map.

2. An LED array according to claim 1 wherein the pre-determined curing map is a representation for controlling the output of each LED zone in respect of any of the following parameters: UV power output; UV output intensity; UV output frequency; and UV output duration.

3. An LED array according to claim 1, wherein each of the LED zones is connectable to a single power supply.

4. An LED array according to claim 1, wherein at least one LED module is individually replaceable.

5. An LED array according to claim 1, wherein at least two of the LED modules are provided adjacent to each other.

6. An LED array according to claim 1, wherein at least two of the LED zones are provided adjacent to each other.

7. An LED array according to claim 1, further comprising a control element for controlling each LED zone independently of the other zones connected to the array.

8. An LED array according to claim 7, wherein the control element is provided within the array.

9. A UV ink curing apparatus comprising one or more LED arrays according to claim 1.

10. An apparatus according to claim 9, comprising at least one power supply.

11. An apparatus according to claim 10, comprising a power supply for each array in the apparatus.

12. An apparatus according to claim 10, wherein the at least one power supply includes an output for each LED zone of an array.

13. A UV print curing method comprising:
grouping a plurality of LED modules into a plurality of LED zones; plotting a pre-determined curing map; and
controlling an output of LED modules within the plurality of LED zones according to the pre-determined curing map.

14. A UV print curing method according to claim 13 wherein the curing map plots the output of each LED module with respect to any of the following parameters: UV power output, UV output intensity, UV output frequency, and UV output duration.
